(19) United States
(12) Patent Application Publication
(10) Pub. No.: US 2015/0288275 A1
(43) Pub. Date: Oct. 8, 2015

(54) Input Current Distortion for Minimization of Bulk Capacitor

(71) Applicants: Ionel Jitaru, Tucson, AZ (US); Marco Antonio Davila, Tucson, AZ (US)

(72) Inventors: Ionel Jitaru, Tucson, AZ (US); Marco Antonio Davila, Tucson, AZ (US)

(21) Appl. No.: 14/680,778

(22) Filed: Apr. 7, 2015

Related U.S. Application Data
(60) Provisional application No. 61/976,761, filed on Apr. 8, 2014.

(51) Int. Cl. H02M 1/42; H02M 7/06

(52) U.S. Cl. CPC H02M 1/42; H02M 7/06

(57) ABSTRACT

Controlled input current distortion that reduces voltage ripple on a power factor corrected output is shown. Several methods are presented to reduce this voltage ripple so that the typical capacitor used in off line converters can be reduced in size or stress without affecting power factor significantly.

### RELATED APPLICATION/CLAIM OF PRIORITY

This application is related to and claims priority from U.S. provisional application Ser. No. 61/976,761, filed Apr. 8, 2014, and entitled Input Current Distortion for Minimization of Bulk Capacitor, and which provisional application is incorporated by reference herein.

### INTRODUCTION

Low power adapters have market pressures to become smaller. One of most difficult problem to solve is the size of the electrolytic capacitors. The reason they are large in small adapters is due to the low line frequency. In order to maintain a steady DC level on the output of the adapter, the adapter has to have enough storage to withstand the times that the AC voltage is low. If the adapter does not have a power factor correction converter, the only way to reduce the bulk capacitance has been to stress the converter more by designing it with more input voltage range. When the input range is increased, stresses on devices become worse and efficiency degrades. Essentially the unit gets hotter if the unit is designed with a smaller capacitor and larger voltage ripple. If the unit is hotter the only way to solve this is to make the unit bigger which defeats the purpose in trying to make the electrolytic smaller in the first place.

When a power factor correction boost power train is used, the electrolytic capacitor size is reduced. The reason for this is that as a boost converter the output voltage is higher than the line. Most power factor converters regulate at high enough voltage that is higher than the peak of the highest input line. This increases the energy storage ability of the electrolytic due to the fact that energy is proportional to C*V*V. It is more sensitive to voltage than capacitance and since electrolytic capacitors sizes stay the same with the same C*V factor, the higher the voltage the higher the energy capability. In addition the input voltage range for the converter after the power factor power train is drastically reduced. This allows other topologies that are more efficient to be used. So, adding another converter reduces the size of the electrolytic and also of the next converter in series. But the size of the power factor converter itself has to be added which adds more components.

Is there any other additional improvement that can be done to reduce the size of the electrolytic further? Presented in this application is a way to reduce ripple and capacitor size further using a power factor correction boost converter.

### SUMMARY OF THE PRESENT INVENTION

The present invention provides a control method for a power factor corrected converter circuit (PFC) that includes a bulk capacitor, comprising distorting an input current shape to the PFC to reduce output root mean square (RMS) current (and its related ripple voltage) into the bulk capacitor.

In one embodiment of the present invention, an input wave shape that is a reference for the PFC is distorted to produce the distorted input current shape.

In another embodiment of the present invention a voltage loop the PFC is intentionally increased in gain so that the PFC current is reduced on the bulk capacitor while not significantly sacrificing power factor performance.

In still another embodiment of the present invention, the PFC has an isolated power factor corrected converter and the bulk capacitor is located in a secondary of the PFC. In one version of this embodiment, the input wave shape that is a reference for the PFC is distorted by to produce the distorted input current shape. In another version of this embodiment, a voltage loop of the PFC is intentionally increased in gain so that the PFC current is reduced on the bulk capacitor while not significantly sacrificing power factor performance.

These and other features of the present invention will become apparent from the following detailed description and the accompanying Drawings

### BRIEF DESCRIPTION OF THE DRAWINGS

FIGS. 1, 2, & 3 show waveforms with ripple in the electrolytic capacitor after a power factor corrected stage, and show how the method of the present invention affects that ripple.

FIG. 4 shows a PFC circuit in accordance with the present invention; and

FIG. 5 shows another PFC circuit in accordance with the present invention

### DETAILED DESCRIPTION

### Input Current Distortion

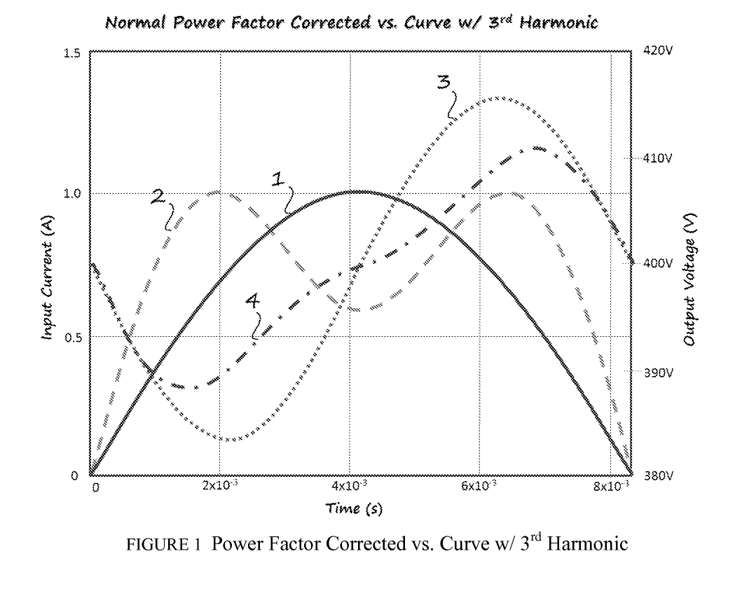

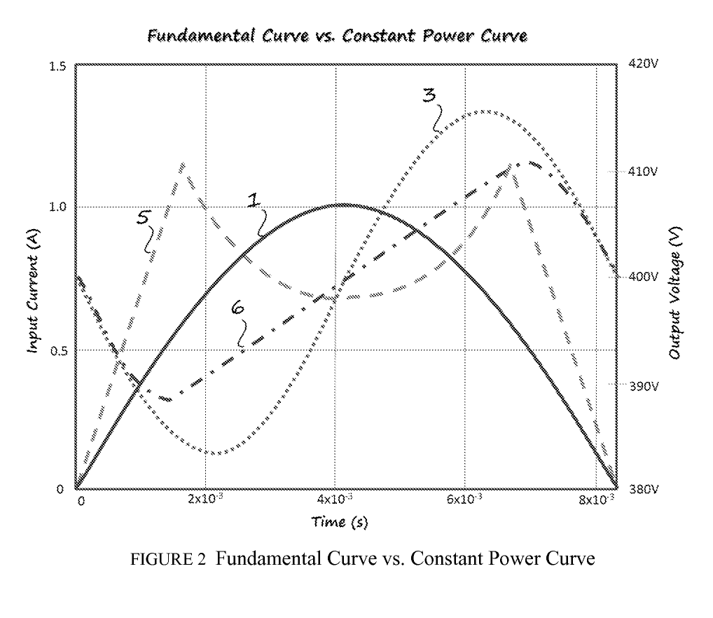

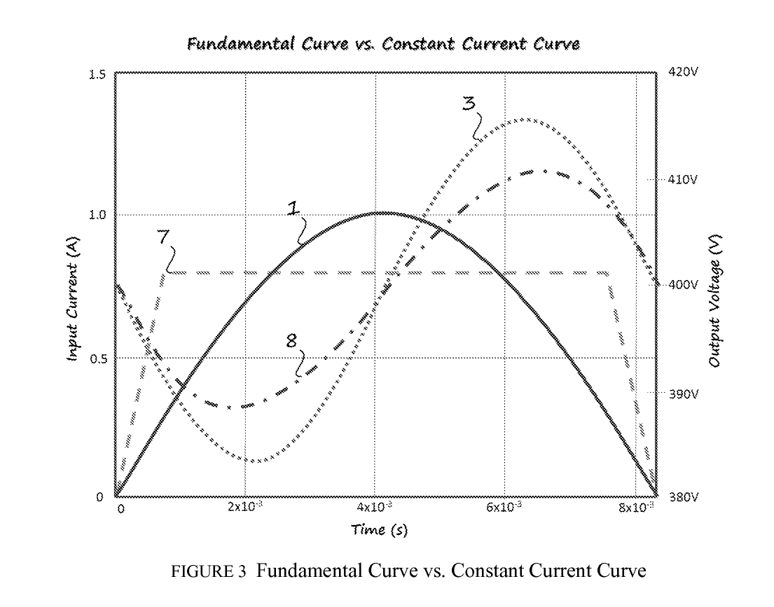

Shown in FIGS. 1, 2, & 3 waveform (3) is the ripple in an electrolytic capacitor after a power factor corrected stage. The input current is shown as waveform (1). Shown is the ripple on a 85 W unit with a typical 22 uF capacitor (actual value is 80% of rated capacitance). The ripple frequency is at double the input frequency of the line. Typically either 60 Hz or 50 Hz is used as the line frequency worldwide. These frequencies would produce ripples of 120 Hz and 100 Hz respectively. The average voltage is maintained by the voltage regulation loop of the power factor correction controller. This voltage is typically close to 400 volts to accommodate household international alternating current outlets. Since the voltage and current are sine waves and are supposed to be in phase, power comes in as a sine times a sine. The instantaneous input power is the following equation (\sqrt{2}·Vacrms·sin(2·π·Fac·t))·(\sqrt{2}·Iacrms·sin(2·π·Fac·t))=(1+cos(2·π·2·Fac·t))·Vacrms·Iacrms. This means that the instantaneous power ranges between 0 and 2 times the average power of the converter at twice the input frequency. The maximum and minimum peak of the ripple occurs when the instantaneous power crosses the average power line. The maximum peak occurs when the instantaneous input power is crossing from above and the minimum when the crossing is from below. The amount of peak to peak voltage ripple in the capacitor is proportional to area under or above the nominal power. In this example, the peak to peak voltage ripple is

$$\frac{Vacrms \cdot Iacrms}{2 \cdot π \cdot Fac \cdot C \cdot Vout} .$$

Where Fac is the input line frequency, C is the capacitor value, and Vout is average output voltage of the PFC stage. Vacrms times Iacrms is input power.

If the RMS, and its related ripple voltage can be reduced, the value of the capacitor can be reduced which would reduce the size of the capacitor. The amount of average power cannot be changed but the peak power could be reduced by distorting the input current. This would change the power factor but in small converters lower power factors are allowed. The minimum power of zero cannot be changed since when the input is at zero volts any value of current will not produce any input power. But what shape would be ideal? The lowest ripple on the capacitor without changing the power factor too much would be the compromise.

Because current must go to zero when the voltage is zero and the current shape must be symmetrical for the half wave of the input line, this puts some constraints on the distortion we can add. This means that harmonic distortion has to be odd frequencies and in phase with the line. Shown in FIG. 1, waveform (3) is the input current with some 3^{rd} harmonic component added to the current. The voltage ripple is shown in waveform (4). A comparison can be made to the original ripple with only the fundamental component in voltage ripple waveform (3). The capacitor ripple voltage is reduced from 32.07 Vpp to 22.226 Vpp by adding 40.7% of the fundamental amplitude as a third harmonic component. This increases the input RMS current 8% but reduces ripple current in the capacitor by 28%. This reduction halves the ripple dissipation in the capacitor so a smaller capacitor can be used. Depending on the converter specifications a compromise between the amount of input current distortion and the reduction of ripple voltage or size of the input capacitor.

An alternate input current shape is shown in FIG. 3 waveform (7) with capacitor voltage ripple shown in waveform (8). In this method, current is proportional to the input voltage up to a certain voltage or angle, beyond this a constant current curve is used. This reduces the ripple lightly. All waveforms were adjusted to produce the same output voltage ripple improvement. In this case, the angle where the constant current is applied is 16.2 degrees. The input current is proportional to input voltage up to this point then is frozen at this level until 180-16.2 degrees where again it follows the voltage down. With this waveform the input RMS current is 5.6% higher and the capacitor current is reduced by 27.6%. Again a compromise can be made between input RMS current and the capacitor ripple.

A stronger affect is shown in FIG. 2 with input current waveform (5) & output ripple voltage waveform (6) where, again, the input current is proportional to the input voltage up a voltage or angle, then after this point the input follows a constant power curve. The input current would be calculated by dividing the power at this angle by the input voltage. The angle is designed to give the same ripple as the other methods is 36 degrees. In this method the amount of ripple desired can be changed by lowering the point at which constant power starts. The waveforms shown have a input current increase of 8.1% while the capacitor ripple current is reduced by 29.1%. During the constant power section the power factor correction controller must “catch” up with the loss of power during the time the current was following the line. As the voltage point or angle is lowered the average power needed during the constant power section is reduced but the input current is increased. Again a compromise can be reached for a specific application.

The flat current method can easily be controlled with a standard power factor control in which the input voltage signal going into the controller is clamped at a specific level. The constant power implementation can be accomplished by changing the normally slow voltage loop in the power factor controller to a faster loop at moment in time when constant power is needed. This increase in gain around the threshold can be gradually done and then gradually removed during each half cycle. This can also be easily accomplished in a microcontroller that follows these equations.

There two possible ways to introduce the distortions mentioned. One is to change the shape of the input voltage waveform that is normally used by the power factor controller to create the input current reference. This will in turn distort the input current regulated by the controller and reduce the ripple into the bulk capacitor. Another technique is to increase the gain of the voltage loop so that a portion of the ripple is regulated out by the controller. But if the gain is too high the controller will try to eliminate all the ripple which will create a much lower power factor on the input. The gain can be increased so that at fundamental ripple on the capacitor it is close to unity.

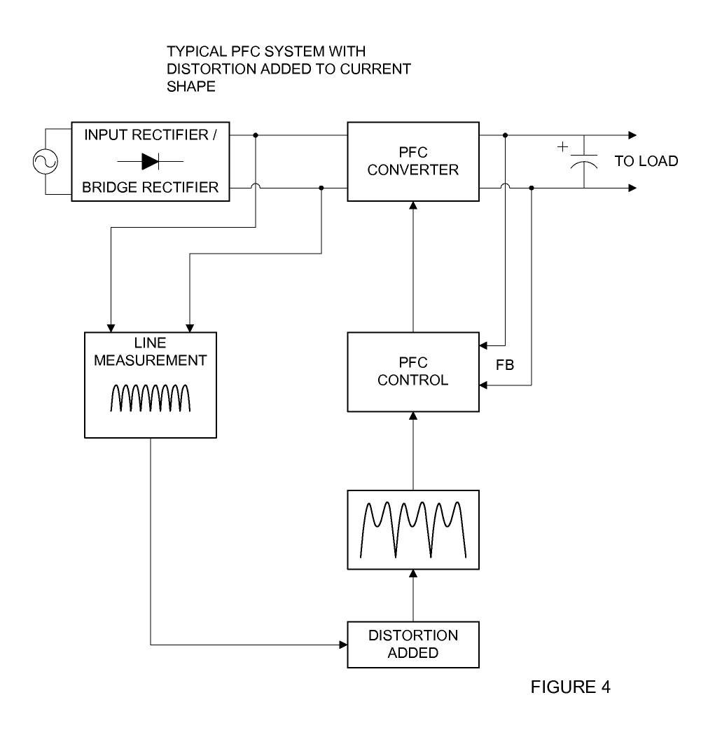

Shown in FIG. 4 is an implementation of the idea of adding distortion. The input voltage is measured to create a reference for the current shape in a typical PFC control circuit. Then this shape is distorted to create the new shape. This new shape is now used in place of the old current shape to produce the new current reference. The distortion can be done with either a clamp, addition of a extra signal, or this can all be processed inside a micro-controller.

All input current distortion techniques presented can be combined to create a blend of different current shapes. In addition other harmonics other than the 3^{rd} harmonic can be added onto the current waveforms in order to improve efficiency, ripple, or for some other purpose.

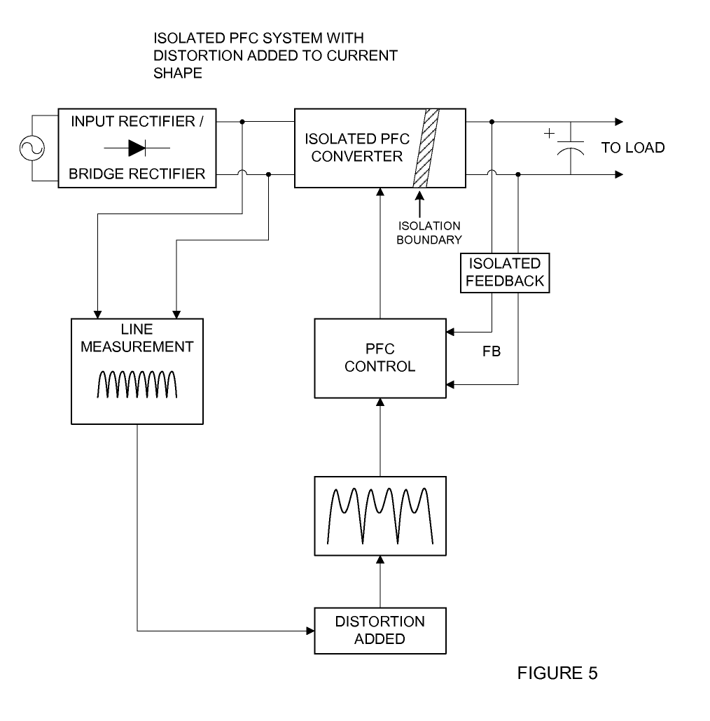

All the current distortion methods mentioned in this disclosure can apply to isolated PFC converters as presented in FIG. 5 as well as any other PFC converter. These ideas are independent of topologies and deal with the energy balance in the bulk output capacitor based on the input power received. This also applies if the bulk capacitor is on the secondary of a converter that fulfills the role of power factor corrector. In some application we would like to eliminate the bulk capacitor in the primary and still have PFC by employing an isolated PFC. In such application by implementing the methodologies described in this patent application we can reduce the RMS current into the bulk capacitor located in the secondary. The distortion methods mentioned in this disclosure will reduce the RMS current on the bulk capacitor regardless of its location in the primary or secondary and will also reduce the power dissipation in the input bridge rectifier presented in FIG. 4 and FIG. 5, increasing the overall efficiency.

Thus, as seen from the foregoing discussion, the applicants have provided a control method for a power factor corrected converter circuit (PFC) that includes a bulk capacitor, which comprise distorting an input current shape to the PFC to reduce output root mean square (RMS) current (and its related ripple voltage) into the bulk capacitor.

In the PFC circuits of FIGS. 4 and 5, the invention can be implemented by changing an input wave shape that is a reference for the PFC by adding distortion to produce the distorted input current shape.

In addition, in the PFC circuits of FIGS. 4 and 5, the invention can be implemented by a voltage loop of the PFC that is intentionally increased in gain so that the PFC current is reduced on the bulk capacitor while not significantly sacrificing power factor performance.

In addition, in the FIG. 5 implementation of the present invention, the PFC has an isolated power factor corrected converter and the bulk capacitor is located in a secondary of the PFC. This embodiment can be implemented when the input wave shape that is a reference for the PFC is distorted to produce the distorted input current shape. This embodiment can also be implemented with a voltage loop of the PFC that is intentionally increased in gain so that the PFC current is reduced on the bulk capacitor while not significantly sacrificing power factor performance.

1. A control method for a power factor corrected converter circuit (PFC) that includes a bulk capacitor, comprising distorting an input current shape to the PFC to reduce output RMS current into the bulk capacitor.

2. The control method of claim 1, wherein an input wave shape that is a reference for the PFC is distorted by to produce the distorted input current shape.

3. The control method of claim 1, where a voltage loop of the PFC is intentionally increased in gain so that the PFC current is reduced on the bulk capacitor while not significantly sacrificing power factor performance.

4. The method of claim 1, wherein the PFC has an isolated power factor corrected converter and the bulk capacitor is located in a secondary of the PFC.

5. The method of claim 4, wherein the input wave shape that is a reference for the PFC is distorted by to produce the distorted input current shape.

6. The method of claim 4, where a voltage loop of the PFC is intentionally increased in gain so that the PFC current is reduced on the bulk capacitor while not significantly sacrificing power factor performance.
